(19) United States
(12) Patent Application Publication
(10) Pub. No.: US 2021/0165979 A1
(43) Pub. Date: Jun. 3, 2021

(54) ITEM TRACKING

(71) Applicant: ENVIO LIMITED, Guiford England (GB)

(72) Inventors: James WILKINSON, London (GB); Harald STROMFELT, Oxfordshire (GB)

(21) Appl. No.: 16/488,268

(22) PCT Filed: Feb. 22, 2018
(86) PCT No.: PCT/GB2018/050458

§ 371 Date: Aug. 23, 2019

(30) Foreign Application Priority Data
Feb. 24, 2017 (GB) 1703064.4

(51) Int. Cl. G06K 7/10; G06Q 10/08

(52) U.S. Cl. CPC G06K 7/10297; G06Q 10/0875

(57) ABSTRACT

An item tracking apparatus for fitting to a container. The apparatus comprises a tag detector for detecting whether a tag fixable to an item is present within the container, a processor unit and a wireless communication unit. The processor unit is connected to the tag detector and the wireless communication unit and arranged to control the wireless communication unit to transmit item tracking data indicative of the presence of the item in the container to a remote server.

### TECHNICAL FIELD

The present invention relates to systems and apparatus for tracking items.

### BACKGROUND

Systems for delivering items are well known and well established. Companies, such as online retailers, have well developed logistics operations allowing consumers to purchase items online and then have the items delivered, usually by a third party delivery company, to a postal address, specified by the consumer.

Item tracking systems exist allowing items being delivered to be “tracked”, i.e. information about the whereabouts of the item to be communicated to relevant parties —e.g. the intended recipient of the item and the sender of the item. Such a system might comprise a tracking device operated by a delivery driver. The tracking device includes a barcode reader allowing barcodes fixed to delivery items to be scanned. The tracking device includes a GPS (Global Positioning System) receiver and a cellular mobile network communication unit enabling information to be communicated from the tracking device to a central server via a cellular mobile network. When items to be delivered are loaded onto a delivery vehicle, the barcode of each item is scanned by the driver using the tracking device. Information is then uploaded from the tracking device, via the communication unit, to the server indicating that each scanned item is in the process of being delivered. The tracking device periodically communicates information to the central server indicating its location (determined using the GPS receiver). In this way, the location of each item being delivered can be tracked. When the delivery driver arrives at a delivery destination for a particular item, the barcode on the item is scanned and the delivery driver inputs information to the delivery unit indicating that the item has been delivered. This information is then communicated from the tracking device to the central server.

Such a tracking system allows item tracking information to be maintained at the central server and provided, via suitable interfaces, to relevant parties. For example, a delivery management system of the sender of the item (e.g. an online retailer) may receive information from the central server allowing successful (and unsuccessful) deliveries to be monitored. Similarly, the recipient of the item may be able to track the progress of the item towards the delivery destination via a web page.

Conventional item tracking systems of the type described above are particularly appropriate and widely used for the delivery of items of high value and/or high importance. However, such systems are limited because, typically, they only permit the tracking of items once—i.e. from the sender of the item to the recipient. Once the item being delivered is removed from the delivery packaging, the delivery process—and the item tracking process—is terminated. If there is a desire or requirement for the item to be sent to another recipient it is typically necessary for the first recipient to arrange for return of the item to the original sender, who will then re-package the item and send it, using the same process as before, to a second recipient.

### SUMMARY OF THE INVENTION

In accordance with a first aspect of the invention, there is provided an item tracking apparatus for fitting to a container. The apparatus comprises a tag detector for detecting whether a tag fixable to an item is present within the container, a processor unit and a wireless communication unit. The processor unit is connected to the tag detector and the wireless communication unit and arranged to control the wireless communication unit to transmit item tracking data indicative of the presence of the item in the container to a remote server.

In accordance with a first aspect of the invention there is provided a device which enables a conventional item delivery container to be adapted so that it can be determined whether or not a tagged item is located within it, and to communicate this information, for example, to a central item tracking server. By virtue of these features, a first party (e.g. the party that originally sent an item) can verify that an item has been returned to the container. As a result, a first recipient of the item can send the item to a second recipient without the item needing to be returned to the original sending party. This arrangement improves conventional item tracking processes because an item can continue to be tracked after it has been delivered to a first recipient.

Optionally, the apparatus further comprises a position detecting unit connected to the processor unit and arranged to generate position data corresponding to a determined position of the apparatus.

Optionally, the processor unit is arranged to control the wireless communication unit to transmit the position data to the remote server.

Optionally, the apparatus further comprises a locking unit connected to the processor unit adapted to lock and/or unlock the container in response to a locking command from the processor unit.

Optionally, the processor unit is adapted to generate the locking command responsive to a command from the remote server.

Optionally, the processor unit is adapted to generate an unlock locking command responsive to the position detecting unit generating position data corresponding to a predetermined position.

Optionally, the processor unit is adapted to generate an unlock locking command responsive to the processor unit generating position data corresponding to a predetermined position using information from the wireless communication unit.

Optionally, the apparatus further comprises a user authentication unit and wherein the processor unit is adapted to generate the locking command responsive to the user authentication unit receiving a predetermined authentication input.

Optionally, the user authentication unit is a Bluetooth unit and the predetermined authentication input is a pairing key received from a user Bluetooth device.

Optionally, the apparatus further comprises a sensor reader unit connected to the processor unit and adapted to receive sensor data from one or more sensor units attachable to the item.

Optionally, the position detecting unit is a global positioning system (GPS) unit.

Optionally, the apparatus further comprises a display unit connected to the processor unit.

Optionally, the display unit comprises an electronic paper (e-paper) display.

Optionally, the processor unit is arranged to receive address data from the server via the wireless communication unit and/or a memory unit of the item tracking apparatus and is arranged to control the display unit to display the address data.

Optionally, the tag detector comprises a RFID (radio frequency identification) tag detector.

Optionally, the apparatus further comprises an electromagnetic shield layer fixable to the container for reducing, in use, RFID tags external to the container being detected by the RFID tag detector.

Optionally, the tag detector comprises a Bluetooth low energy (BLE) beacon detector.

Optionally, the wireless communication unit comprises a cellular network transceiver.

Optionally, the item tracking apparatus according further comprises a pressure sensing membrane.

In accordance with a second aspect of the invention there is provided an item tracking system for tracking an item. The system comprises an apparatus fitted to a container and a server. The apparatus comprises a tag detector for detecting whether a tag fixable to an item is present within the container, a processor unit and a wireless communication unit. The processor unit is connected to the tag detector and the wireless communication unit and arranged to control the wireless communication unit to transmit item tracking data indicative of the presence of the item in the container to the server.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a schematic diagram of an item tracking apparatus in accordance with certain embodiments of the invention;

FIG. 2 provides a schematic diagram of an item tracking apparatus in accordance with certain embodiments of the invention;

FIG. 3 provides a schematic diagram of an item tracking apparatus positioned within a container in accordance with certain embodiments of the invention;

FIG. 4 provides a schematic diagram of an item tracking system in accordance with certain embodiments of the invention, and

FIG. 5 provides a schematic diagram of an item tracking apparatus positioned within a container in accordance with certain further embodiments of the invention.

### DETAILED DESCRIPTION

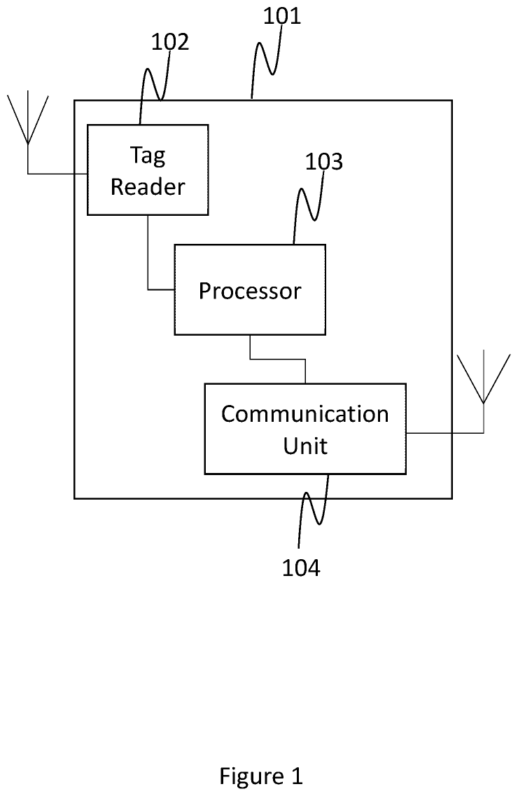

FIG. 1 provides a simplified schematic diagram of an item tracking apparatus in accordance with certain embodiments of the invention.

FIG. 1 depicts an item tracking apparatus 101 arranged to be fitted to an item container. The item tracking apparatus 101 includes a tag detector 102 for detecting the presence of a tag attached to an item within the item container. The tag detector 102 is connected to a processor unit 103 which controls operation of the tag detector 102 and receives tag detection information generated by the tag detector 102. The processor unit 103 is also connected to a wireless communication unit 104. The processor unit 103 is arranged to generate item tracking data based on the tag detection information received from the tag detector 102. The item tracking data can include information indicating the presence or absence of a tag, and an identity associated with the tag. The processor unit 103 is arranged to control the wireless communication unit 104 to transmit the item tracking data so, for example, it can be received, via a suitably arranged data network, by a suitably arranged remote application server on which is running item tracking software.

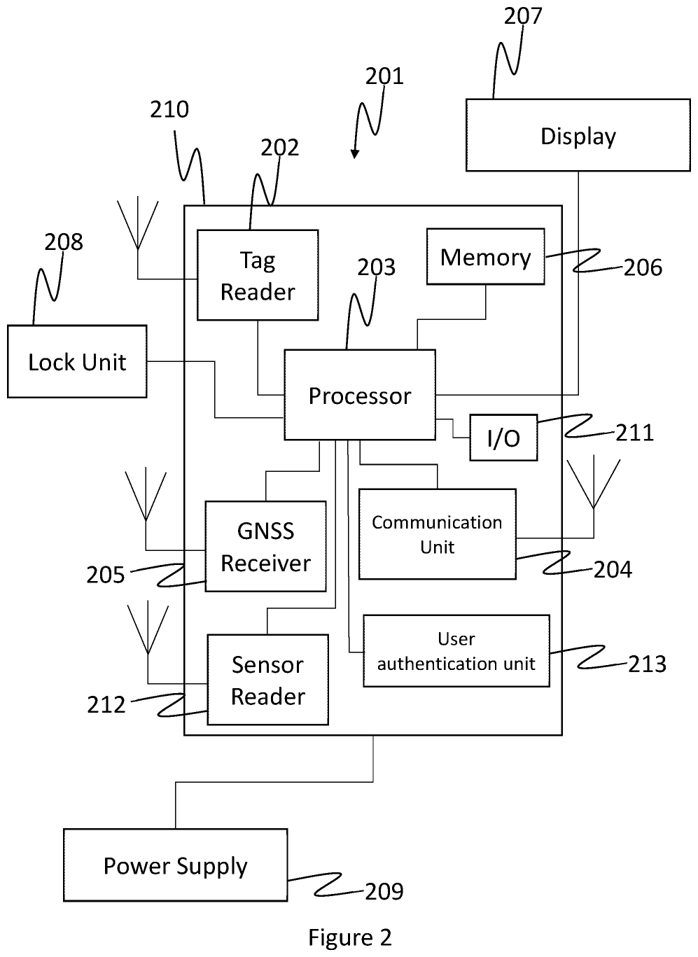

When fitted to an item container the item tracking apparatus 101 allows the presence or absence of an item within the item container to be monitored from a remote location. As will be understood, the components of the item tracking apparatus can be provided by any suitable means and arranged in any suitable way to achieve this function. FIG. 2 provides a simplified schematic diagram showing an item tracking apparatus 201 in accordance with certain embodiments of the invention. The item tracking apparatus shown in FIG. 2 corresponds to that shown in FIG. 1 but includes further components.

The item tracking apparatus 201 includes a tag detector 202, such as an RFID reader, connected to a processor unit 203 provided, for example, by a suitably programmed microprocessor. As is known, RFID tags typically contain a chip and antenna and transmit a signal containing identifying information on reception of an interrogation signal transmitted from a tag detector. “Passive” RFID tags contain no energy source and are powered by energy from the interrogation radio waves. Other “non-passive” RFID tags may contain a power source enabling, for example a signal to be transmitted at a greater strength, and thus propagate further, than a passive RFID tag.

The tag detector is arranged to periodically perform a tag detection operation to detect any tags present within the item container. If a tag is detected, the tag detector 202 communicates a “tag detected” message to the processor unit 203 indicating that a tag has been detected within the item container. In certain embodiments, the tag detector 202 performs a tag detection operation 500 times a second. In other examples, the frequency of the tag detection operation may be reduced, for example to conserve power. In this way, the processor unit 203 can track tags within the item container and identify when tags have been removed from the item container.

In certain embodiments, the tag detector 202 detects a tag identifier associated with the tag and includes this with the tag detected message sent to the processor unit.

The processor unit 203 is connected to a wireless communication unit 204 provided, for example, by a mobile cellular network transceiver unit enabling data to be communicated to and from an application server via a data network such as a public land mobile network (PLMN). As described above, on receipt of a “tag detected” message, or on detection that a tag has been removed, the processor unit controls the wireless communication unit to transmit corresponding item tracking data to a remote location, for example an item tracking server.

The item tracking apparatus 201 further includes a position detecting unit 205 such as a global navigation satellite system (GNSS) receiver connected to the processor unit 203. The position detecting unit 205 is provided by, for example, a global positioning system (GPS) unit, and is arranged to generate position data corresponding to a determined position and to communicate this to the processor unit 203. The processor unit 203 is further connected to a memory unit 206 allowing data to be stored and retrieved by the processor unit 203 and for storing computer program instructions executed by the processor unit 203.

In certain embodiments, the tag detector 202 is activated by the processor unit 203 in response to certain conditions being met. For example, the processor unit 203 identifying that position data generated by the position detecting unit 203 corresponds to a predetermined position.

The item tracking apparatus 201 further includes a display unit 207 connected to the processor unit 203 and arranged to display display data generated by the processor unit 203. The item tracking apparatus 201 also includes a locking unit 208 connected to the processor unit 203 and a power supply 209 for powering the components of the item tracking apparatus 201. The power supply can be provided by any suitable means known in the art. In certain embodiments, the power supply is provided by a conventional lithium-ion battery unit.

The locking unit 208 includes a locking mechanism which can lock shut (i.e. prevent the opening) of the item container. The locking mechanism of the locking unit can lock and/or unlock the locking mechanism responsive to a command from the processor unit 203. The locking unit can be provided by any suitable remotely controllable electronic lock unit. In certain embodiments, the locking unit comprises a locking mechanism comprising a bolt which is thrown and withdrawn by an electrically activated mechanism such as a linear solenoid as are known in the art.

The item tracking apparatus 201 further includes input/output interface 211 enabling information, for example firmware updates, to be communicated to the processor unit 203 and memory unit 206. Such an input/output interface can be provided by any suitable means, for example a micro USB port.

As indicated schematically in FIG. 2, in certain embodiments the display unit 207, the locking unit 208 and the power supply 209 are external to a casing 210 housing the other components of the item tracking apparatus 201 discussed above.

As shown in FIG. 2, in certain embodiments the item tracking apparatus further includes a sensor reader unit 212 for communicating sensor data with one or more sensor units attached to the item and a user authentication unit 213 for authenticating a recipient of the item container. In certain embodiments, the user authentication unit 213 can be provided by a Bluetooth unit as described in more detail below.

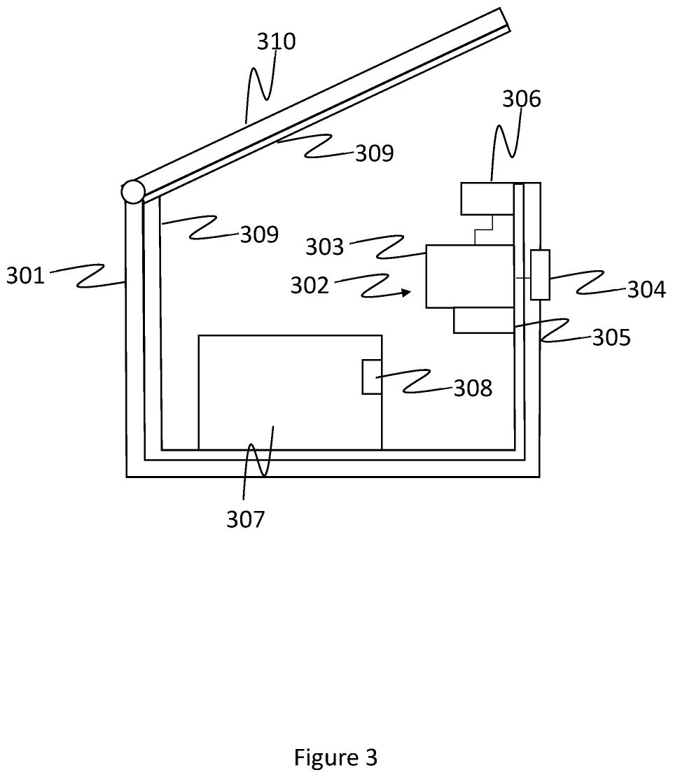

FIG. 3 provides a simplified schematic diagram of an item container 301 within which is fixed an item tracking apparatus 302 in accordance with certain embodiments of the item tracking apparatus described above. The item tracking apparatus 302 includes a casing 303 external to which is a display unit 304, a power supply unit 305 and a locking unit 306.

The item container 301 can be provided by any suitable container, for example of the type intended for the delivery of items. Typically, the item container 301 will be made from a rugged material (such as strong cardboard or plastic) to protect the item, and thus the item tracking apparatus. Typically, the item tracking apparatus is fixed to the container in any suitable way, for example by mechanical means such as nuts and bolts or pop rivets or by adhesive means such as glue or adhesive tape.

As can be seen from FIG. 3, the item container 301 includes a lid 310 which can be opened and closed. When in the closed position the lid 310 can be secured in the closed position by virtue of a locking mechanism provided by the locking unit 306. Further, as can be seen from FIG. 3 the display unit 304 is fixed in place such that at least part of the display unit 304 is visible on an outward facing portion of the item container 301.

FIG. 3 shows an item 307 within the item container 301. The item 307 has attached to it a tag 308 detectable by the tag detector of the item tracking apparatus 302. As described above, in certain embodiments the tag detector of the item tracking apparatus 302 is an RFID tag detector. In such embodiments, the tag 308 attached to the item 307 is an RFID tag.

Although not shown in FIG. 3, typically the inside of the item container 301 includes a protective insert which includes a cutaway section that the item 307 fits into. The protective insert may be made from any suitable material known in the art such as polyurethane foam. In this way, the item 307 is held securely within the container 301.

In such examples, the protective insert may include a cutaway section to accommodate the parts of, or the whole of, the item track tracking device. In this way, the item tracking apparatus may be partly or entirely embedded in the protective insert.

In the example shown in FIG. 3, the item container 301 is lined on an inner surface by an electromagnetic shield layer 309. The electromagnetic shield layer 309 is arranged such that in embodiments in which the tag detector of the item tracking apparatus 302 detects the item tags by virtue of electromagnetic radiation (e.g. RFID tags), the likelihood of tags external to the item container 301 being detected is substantially reduced. In this regard, the electromagnetic shield layer 309 acts as a Faraday cage. As will be understood with reference to FIG. 3, in order to “complete” the Faraday cage it would be necessary for the lid 310 to be closed. However, even with the lid 310 in the open position the presence of the electromagnetic shield layer 309 reduces the likelihood of electromagnetic based tags external to the item container 301 being detected.

In certain embodiments the display unit of the item tracking apparatus is provided with an electronic paper (“e-paper”) display. As is known in the art, such displays are based on, for example, electrophoretic displays and are widely used in applications such as e-readers. Such displays are advantageous in that they consume a low amount of power and are similar in appearance to conventional ink on paper.

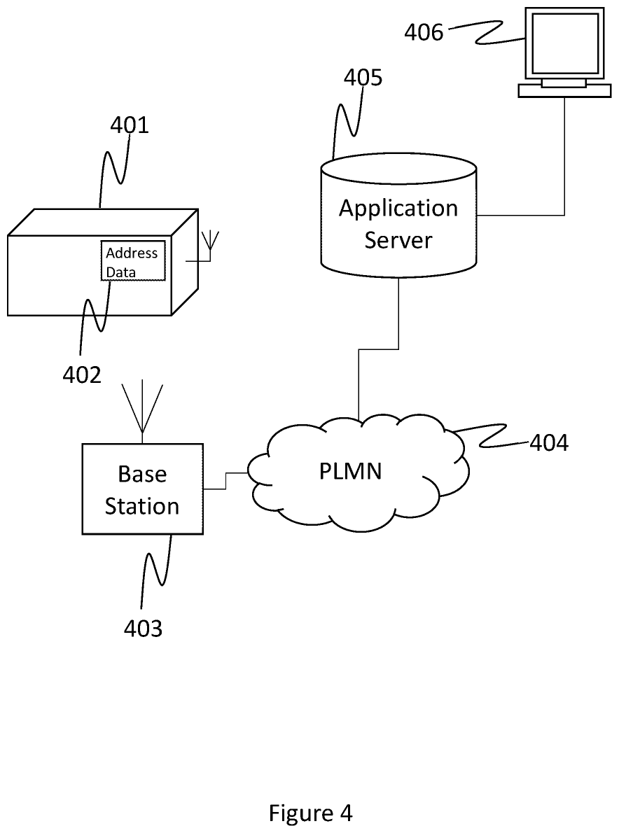

FIG. 4 provides a simplified schematic diagram of an item tracking system in accordance with certain embodiments of the invention.

An item container 401 is provided with an item tracking apparatus as described above. The item tracking apparatus is mounted within the item container 401 such that an antenna of the wireless communication unit can send and receive data and such that the display 402 of the display unit is visible on an external surface of the item container 401.

In use, an item with a tag affixed is placed within the item container 401. Address data is loaded onto the item tracking apparatus (e.g. via the input/output interface) and a first address is displayed on the display 402 of the display unit. The address data can be in any suitable format allowing a delivery address to be identified. In some embodiments, the address data includes text data corresponding to a conventional postal address (e.g. the name of the intended recipient, a building number, street, town, region, country, postcode etc). Additionally or alternatively, the address data can include a machine-readable code such as a barcode or QR code which encodes a postal address. In some examples, the address data is simply a unique identifier. The unique identifier may be associated with a postal address and/or delivery instructions and/or customer details in a central database maintained by a delivery company.

The item container 401 then enters a conventional delivery process, such as a postal service, and is posted to the address indicated on the display of the display unit.

When the item has been received at the address indicated on the display of the display unit, the recipient removes the item from the item container 401. The item tracking apparatus determines that the item has been removed from the item container 401 as the tag on affixed to the item is no longer detected by the tag detector.

Item tracking data indicating that the item has been removed is generated by the processor unit and sent to the wireless communication unit for transmission. In the example shown in FIG. 4, the wireless communication unit is a mobile cellular network transceiver unit. The item tracking data is transmitted from the wireless communication unit of the item tracking apparatus to a base station 403 of a PLMN and communicated via the network infrastructure 404 of the PLMN to an application server 405. The application server has running thereon item tracking software allowing the tag of the item, and thus the item itself to be tracked.

Once the recipient has finished with the item, they place the item back in the item container 401. This is detected by the tag detector. Item tracking data is then communicated from the item tracking apparatus to the application server 405 indicating that the item has been returned to the item container 401.

In certain embodiments, responsive to receiving the item tracking data indicating the item has been returned to the item container, the item tracking software running on the application server 405 controls the application server to transmit an address update instruction to the item tracking apparatus, via the PLMN. Responsive to the receipt of the address update instruction, the processor unit of the item tracking apparatus controls the display unit to display updated address data and a second address is displayed on the display unit. In certain embodiments the updated address data is stored in the memory of the item tracking apparatus or is included in the address update instruction from the application server.

In certain embodiments, the processor unit controls the display unit to display updated address data based on alternative or additional conditions. In some examples the updated address data is displayed at a predetermined time and date.

In certain examples, the item tracking software running on the application server is integrated with a system provided by a third party delivery company. Responsive to receiving an indication from the third party delivery company that the item container has been delivered, an address update instruction is transmitted from the application server. In such embodiments, the processor unit can immediately update the address data displayed, or can wait for a predetermined period of time before updating the address data.

Once the address data has been updated, the recipient can then send the item container to the second address using a conventional delivery process, such as a postal service. The item container is then received by a second recipient at the second address and the process can repeat so the item, when returned to the item container 401, can be sent to a third recipient and so on.

The system shown in FIG. 4 includes an administrator terminal 406 connected to the application server 405. The administrator terminal 406 allows an administrator to oversee operation of the system by controlling the item tracking software.

As described above, in certain embodiments the item tracking apparatus includes a position detecting unit which is arranged to generate position data corresponding to a determined position of the item tracking apparatus. In certain examples, the processor unit of the item tracking apparatus is arranged to control the wireless communication unit to transmit the position data to the application server. As will be understood, this enables the item tracking software to identify the location of the item. This information is then available to an administrator operating the administrator terminal 406.

As described above, in certain embodiments the item tracking apparatus includes a locking unit which can lock and/or unlock a locking mechanism responsive to receiving a locking command from the processor unit. Typically, the locking command is a “lock” locking command causing the locking unit to lock the locking mechanism or is an “unlock” command causing the locking unit to unlock the locking mechanism.

In certain embodiments, the processor unit generates an “unlock” locking command when it determines, using information (position data) generated by the position detecting unit, that it is in a predetermined location. The predetermined location is typically stored in the memory of the item tracking apparatus and corresponds to the location of the address to which the item is to be delivered.

Additionally or alternatively, in certain embodiments, the processor unit generates a locking command in response to receiving a remotely generated locking command from the application server via the wireless communication unit.

As described above, in certain embodiments the processor unit generates an “unlock” command based on it being detected that the item container is in a particular location. Typically this is based on position data generated by the position detecting unit. However, in certain circumstances, the position detecting unit may not be able to generate accurate position data or provide position data within an acceptable period of time. If the position detecting unit is a GNSS (e.g. GPS) unit, this may be because suitable reception of the satellite positioning is not achieved (due, for example to noise or other environmental considerations such as severe multipath propagation).

To operate in such circumstances, in certain embodiments the processor unit is provided with assisted GPS (A-GPS) functionality (typically supported by a network operator of the PLMN via which the communication unit transmits and receives data) which enables data received from the PLMN to be used to assist in the generation of the position data.

In certain embodiments, the processor unit generates position data using information from the communication unit alone, for example extracting control plane signals from the communication unit indicating base station identity and signal strength. In such embodiments, the base station identities and locations are stored in the item tracking apparatus (e.g. in a memory connected to the processor), then, the processor unit performs a base station triangulation process to determine a location of the item tracking apparatus. In this way, the processor is adapted to generate an “unlock” locking command responsive to the processor unit generating position data corresponding to a predetermined position using information from the wireless communication unit.

In certain circumstances, it may not be possible for accurate position information to be generated at all. Such circumstances may arise when neither the position detecting unit nor the communication unit can reliably receive a signal. This may be due to noise or environmental factors such as being in an enclosed space where radio signals from a remote transmitter (e.g. PLMN base station or GNSS satellite) are severely attenuated. Therefore, in certain embodiments, the item tracking apparatus is provided with a user authentication unit that enables the processor unit to generate the “unlock” locking command without determining that it is in the correct location.

In certain embodiments, the user authentication unit is provided by a user input means connected to the processor, for example a keypad, allowing a user to enter identification information (a predetermined authentication input), such as a password communicated separately to the user. The password is stored in the memory of the item tracking apparatus and when it is entered via the user input means, the processor unit generates the “unlock” locking command.

In certain embodiments, the user authentication unit is provided by a short-range wireless communication device, such as a Bluetooth unit connected to the processor unit and which can be “paired” with a conventional device, such as a Bluetooth equipped smart phone. In one example embodiment, when the recipient receives the item container, they use a Bluetooth equipped smart phone to undertake a conventional Bluetooth “pairing” process with the Bluetooth unit provided with the item tracking apparatus fitted to the container. During this process, the user is required to enter a pairing pass code (a pairing key) on their smart phone to enable the smart phone to pair with the Bluetooth unit of the item tracking apparatus. The correct pass code is stored on the Bluetooth unit. The correct pass code is communicated to the recipient (e.g. via email, SMS etc) separately to the delivery of the item container.

In the event that the correct pass code is input by the user to the smart phone, the Bluetooth unit is adapted to generate a pass code success message to the processor. Responsive to this, the processor unit generates an “unlock” locking command.

As mentioned above, in certain examples, the item tracking software running on the application server is integrated with a system provided by a third party delivery company. In certain embodiments, responsive to receiving an indication from the third party delivery company that the item container has been delivered, the application server generates an “unlock” locking command which is transmitted to the item tracking apparatus and, consequently, the locking mechanism of the locking unit is unlocked. In certain embodiments, the indication from the third party delivery company may be responsive to the recipient “signing” a terminal of a delivery operative that generates a “delivery complete” message which is communicated, for example via a PLMN, to the application server of the third party delivery company. In response to receiving the “delivery complete” message, the application server of the third party delivery company communicates the indication that the item container has been delivered to the application server running the item tracking software running on.

As described above, in certain embodiments of the invention, the processor unit can generate the “unlock” locking command under different conditions. In certain embodiments, the “unlock” locking command will only be generated responsive to specific combinations of these conditions. For example, in certain embodiments the unlock locking command may only be generated if the item tracking apparatus has received the “unlock” locking command from the remote application server and a user has entered correct information using the user authentication unit.

In certain examples, the processor unit of the item tracking apparatus will control the locking unit to lock the item container shut when it detects that the item has been returned to the item container.

The embodiments described above have been described mainly in terms of an item container containing a single item with a single tag. In certain implementations an item container may contain multiple items each with an individual tag. As will be appreciated, the tag detector of an item tracking apparatus in accordance with certain embodiments of the invention can identify the presence of a tag and also an identifier associated with the tag. This is the case, for example, if the tag detector is an RFID detector and the tag is an RFID tag. In such embodiments multiple items can be tracked within an item container. Tag identifier data can also be communicated from the item tracking apparatus back to the application server. Arranging the tag detector to read a tag identifier also ensures that the correct item is replaced in the item container before the item container is readdressed and delivered to the next recipient. “Inventory control” functionality can also be implemented, for example at the application server, monitoring which items are in an item container at any one time. In certain embodiments, an “inventory check” command can be transmitted from the application server. On receipt of such a command, the processor is arranged to activate the tag reader and to read all of the tags within the container and then communicate this information back to the application server.

In certain embodiments the item tracking apparatus is arranged to detect further information from an item. For example, as shown in FIG. 2, in certain embodiments the item tracking apparatus includes a sensor reader unit for communicating data to and from sensors attached to the item. The sensors can be provided by IC (integrated circuit) packages comprising one or more microsensor and a suitable wireless data transceiver. In certain embodiments such sensors include inertial sensors for recording physical forces that the item has been exposed to. When the item is returned to the item container the inertial sensors transmit recorded sensor data to the processor unit which can then store in the memory unit and/or transmit this analytic data to the application server. In this way, the way in which items have been treated by recipients can be monitored. In certain embodiments, the sensor reader and the tag detector can be integrated into a single unit and, in certain embodiments, the tag and the sensors affixed to the item are provided in a single unit.

In certain embodiments, using the tag detector, the processor unit can record how long an item has been outside of the item container. For example, in conjunction with the tag detector, the processor unit is arranged to detect when the item has been removed from the item container. As soon as the processor unit determines that this has occurred, a timer is activated. Once the processor unit, in conjunction with the tag detector, determines that the item has been returned to the item container, the timer stops. The period of time between the timer starting and stopping is then used to generate analytic data which can be stored in the memory of the item tracking apparatus and/or transmitted to the application server. In certain embodiments, the processor unit can additionally record how many times the item has been removed and then replaced in the item container use this information to generate analytic data for storing and/or transmitting.

In certain embodiments described above, the communication unit has been described in terms of a mobile cellular network transceiver (e.g. a GSM, GPRS, UMTS or LTE transceiver). In certain embodiments, the wireless communication unit may alternatively or additionally include other forms of wireless transceiver such as a transceiver based on the IEEE 802.11 wireless standards, the Zigbee and/or Bluetooth wireless standards

As described above, typically a tag is fixed to an item to be tracked. In certain embodiments, the tag is fixed to the item such that its removal from the item will cause the tag to cease to function. For example, in certain embodiments in which the tag detector is an RFID tag detector or similar, RFID tags fixed to items are glued to the item such that peeling the RFID tag from the item causes functionality such as the tag transmitter within the tag to be destroyed.

In the examples described above, the processor unit has been depicted and described as a single processor unit. In certain embodiments, the functionality provided by the processor unit may be physically distributed across one or more further interconnected processor units. Similarly, it will be understood that the functionality associated with the application server can be implemented across one or more interconnect servers.

In certain embodiments, the item tracking apparatus may include multiple tag readers connected to the processor unit. In certain embodiments, the multiple tag readers may be distributed/spaced around the inside of the item container increasing a tag reading “coverage area” to reduce a chance that an item tag is not read because it is obscured, for example by a metallic part of an item.

In certain embodiments, an additional tag reader may be connected to the processor unit which includes a tag reading antenna arranged so that it protrudes though an outer wall of the item container. In this way, tags in the vicinity of the item container can also be read. In certain embodiments, the processor unit can infer information from strength of a signal received from such a tag reader about the distance of a tag from the item container.

Various modifications can be made to the embodiments of the invention described above.

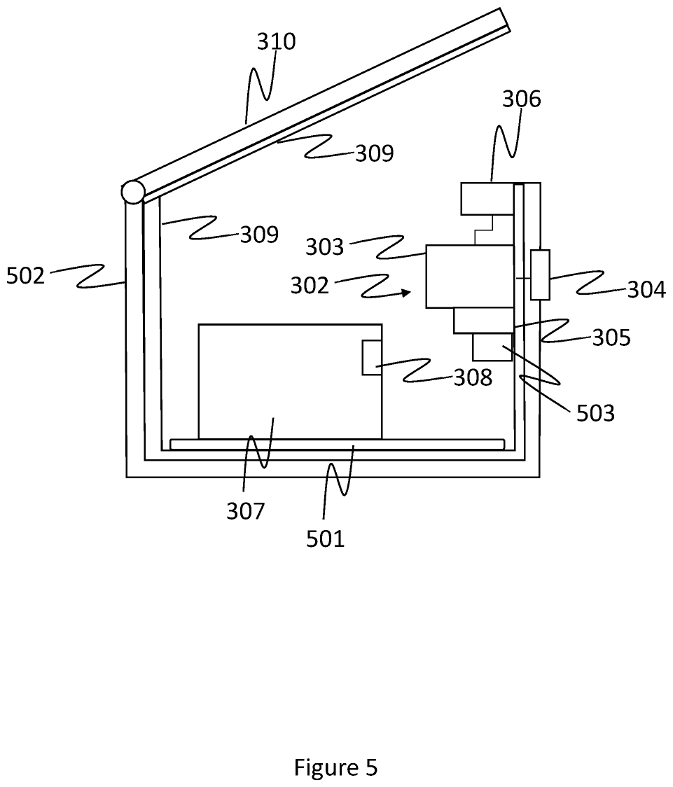

In certain embodiments, an item tracking apparatus is provided that includes a pressure sensing membrane (for example the “Pressure Sensor Tex” pressure sensing membrane provided by Sensing Tex, S.L.). Such membranes are arranged to generate an output signal indicative of which parts of the membrane are subject to pressure arising due to contact with an item. The membrane is arranged so that it can be disposed on an inner surface of the container. In this way, the shape of the part of the item in contact with the membrane can be determined. This is explained further with reference to FIG. 5.

FIG. 5 provides a schematic diagram of an item tracking container and item tracking apparatus corresponding to the item tracking container and item tracking apparatus shown in FIG. 3 (corresponding parts are identified with corresponding reference numerals).

However, the item tracking apparatus shown in FIG. 5 includes a pressure sensing membrane 501 disposed on an inner surface of the item tracking container 502.

The pressure sensing membrane 501 is connected to the item tracking apparatus via a suitable data connection, e.g. a data cable/lead, (not shown) enabling pressure data indicating which parts of the membrane are subject to pressure to be communicated to the processor unit of the item tracking apparatus.

In certain embodiments, the processor unit is adapted to process pressure data to identify the shape of the item in contact with the pressure sensing membrane, and in certain embodiments the processor is adapted to identify the item from the identified shape. Item shape data can be communicated from the item tracking apparatus to an application server running item tracking software.

In the embodiments described above, the tag is described mainly in terms of a RFID tag and, correspondingly the tag detector is described mainly in terms of a RFID tag detectors. However, other types of tags (such as active tags) and tag detectors can be used. In certain embodiments, the tag detector is a Bluetooth tag detector adapted to detect active (i.e. powered) Bluetooth tags. Examples of such Bluetooth tag detectors include Bluetooth low energy (BLE) beacon detectors for detecting tags comprising Bluetooth low energy beacons (BLE) beacons.

In the embodiments described above, item tracking apparatus have been described in terms of items beings delivered to users in a conventional retail context, e.g. a customer buying an item online, and then having the item delivered.

However, item tracking apparatus and systems in accordance with certain embodiments of the invention can be used in other contexts. For example, in an industrial setting, it may be desirable to have assurance that a particular piece of equipment, for example a safety critical tool, is in a location where it might be needed. In such settings, a tag could be affixed to the tool and placed in a container in which an item tracking apparatus is fitted. As described above, the item tracking apparatus can communicate back to an application server on which is running item tracking software item tracking data and position data indicating that the tool is in the container and the container is in a particular location. In this way, the presence of the tool at the location can be determined.

In other settings, item tracking apparatus and systems in accordance with certain embodiments of the invention can be used to provide analysis information for optimising complex supply chains. Specifically, for example, the number of times a particular item was used (i.e. removed from the container) can be tracked, along with the frequency of use (e.g. is the item removed and returned to the container at regular or irregular intervals) and at which location or locations the item was removed and returned to the container.

Similarly, in certain examples, the number of times and/or length of time that a particular item has been removed from a container can be used to implement a “pay-as-you-go” system. In such a system the number of times, or length of time, a particular item, e.g. a tool, is removed from the container is used as the basis to charge a user for use of the tool.

In certain examples, item tracking apparatus and systems can be used to infer which item was used for a particular task. For example, if a tagged tool was removed from a container at a particular location and was absent from the container for a predetermined period of time corresponding to a length of time required to do a particular task, it can be inferred that the tagged tool was used to perform the task. In this way, the particular tool used to perform a particular task can be identified. Accordingly, for example, item tracking apparatus and systems in accordance with certain embodiments of the invention can be used to determine (infer) that a certified tool was used to perform a task requiring a certified tool to be used.

FIG. 5 further shows an inertial charging unit 503 that in certain embodiments may additionally be provided with the item tracking apparatus. The inertial charging unit 503 is arranged to store kinetic energy transferred to the container as it is moved and then convert this kinetic energy into electrical energy to charge the power supply 305. Advantageously, this can extend the life of the power supply 305 and reduce the frequency of charging. An example inertial charging unit is the ECO 200 provided by EnOcean GmbH.

In embodiments of the invention described above, the wireless communication unit of the item tracking apparatus is provided by a mobile cellular network transceiver unit enabling data to be communicated to and from an application server via a data network such as a public land mobile network (PLMN). In other embodiments, the wireless communication unit may be provided by other means, for example wireless communication unit adapted to communicate data using a satellite data connection, provided by a satellite communication provider such as a Globalstar. Advantageously, in such embodiments, data can be communicated to and from the item tracking apparatus irrespective of whether or not the item tracking apparatus is within the coverage area of a cellular mobile network.

As described above, typically the inside of the item container includes a protective insert with a suitably shaped cutaway section for securing the item within the container. In certain embodiments, particularly for items where the tag is positioned in a predetermined location, the cutaway section is oriented to ensure that the tag is positioned adjacent, or in an appropriate position relative to, the tag detector.

In certain embodiments, sensors can be fitted to the container and connected to the processor unit of the item tracking apparatus which are arranged to detect movement of the container such as one or more of accelerations, vibrations, mechanical shocks and tilts that the container is subject to. In this way, the processor unit can gather information to be transmitted back to the application server about the way in which the container has been treated. Similarly, further sensors can be attached to the container and connected to the processor unit which detect moisture and/or humidity and light exposure inside and/or outside the container. In certain embodiments, such sensors, for example sensors arranged to detect movement of the container, are used by the processor to deactivate and activate other components of the item tracking apparatus to reduce power consumption. For example, the processor can be arranged to power down selected components of the item tracking apparatus, such as the wireless communication unit, position detecting unit and tag detector, or any other component that can be temporarily deactivated, if it is detected that the container has not been subject to movement for a predetermined period of time. The processor can be arranged to activate components of the item tracking apparatus again if container movement is detected.

In the embodiments described above, item detection within the container is described in terms of detection of a tag by a tag detector. In certain embodiments, further item detection techniques can be employed, for example using light gates and/or cameras.

As described above, in certain embodiments, address data is displayed on the display of the item tracking apparatus. In certain embodiments, alternative or additional information is displayed in the display. For example if the item tracking apparatus is connected to sensors fitted to the container which detect that the container has been subject to higher than expected levels of physical motion (e.g. drops, knocks and other types of physical forces that may harm the content of the container) or higher than acceptable levels of moisture or humidity, the display can display container status information indicating that the container and/or its content has been subject to potential damaging physical treatment.

In certain embodiments, the processor unit can be arranged to control the display to display special instructions relating to the item within the container. For example, if the item is fragile.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An item tracking apparatus for fitting to a container, said apparatus comprising a tag detector for detecting whether a tag fixable to an item is present within the container, a processor unit and a wireless communication unit, wherein
the processor unit is connected to the tag detector and the wireless communication unit and arranged to control the wireless communication unit to transmit item tracking data indicative of the presence of the item in the container to a remote server.

2. An item tracking apparatus according to claim 1, further comprising a position detecting unit connected to the processor unit and arranged to generate position data corresponding to a determined position of the apparatus.

3. An item tracking apparatus according to claim 2, wherein the processor unit is arranged to control the wireless communication unit to transmit the position data to the remote server.

4. An item tracking apparatus according to claim 3, further comprising a locking unit connected to the processor unit adapted to lock and/or unlock the container in response to a locking command from the processor unit.

5. An item tracking apparatus according to claim 4, wherein the processor unit is adapted to generate the locking command responsive to a command from the remote server.

6. An item tracking apparatus according to claim 4, wherein the processor unit is adapted to generate an unlock locking command responsive to the position detecting unit generating position data corresponding to a predetermined position.

7. An item tracking apparatus according to claim 4, wherein the processor unit is adapted to generate an unlock locking command responsive to the processor unit generating position data corresponding to a predetermined position using information from the wireless communication unit.

8. An item tracking apparatus according to claim 4, further comprising a user authentication unit and wherein the processor unit is adapted to generate the locking command responsive to the user authentication unit receiving a predetermined authentication input.

9. An item tracking apparatus according to claim 8, wherein the user authentication unit is a Bluetooth unit and the predetermined authentication input is a pairing key received from a user Bluetooth device.

10. An item tracking apparatus according to claim 1, further comprising a sensor reader unit connected to the processor unit and adapted to receive sensor data from one or more sensor units attachable to the item.

11. An item tracking apparatus according to claim 2, wherein the position detecting unit is a global positioning system (GPS) unit.

12. An item tracking apparatus according to claim 1, further comprising a display unit connected to the processor unit.

13. An item tracking apparatus according to claim 12, wherein the display unit comprises an electronic paper (e-paper) display.

14. An item tracking apparatus according to claim 12 wherein the processor unit is arranged to receive address data from the server via the wireless communication unit and/or a memory unit of the item tracking apparatus and is arranged to control the display unit to display the address data.

15. An item tracking apparatus according to claim 1, wherein the tag detector comprises a RFID (radio frequency identification) tag detector.

16. An item tracking apparatus according to claim 15, wherein the apparatus further comprises an electromagnetic shield layer fixable to the container for reducing, in use, RFID tags external to the container being detected by the RFID tag detector.

17. An item tracking apparatus according to claim 1, wherein the tag detector comprises a Bluetooth low energy (BLE) beacon detector.

18. An item tracking apparatus according to claim 1, wherein the wireless communication unit comprises a cellular network transceiver.

19. An item tracking apparatus according to claim 1 further comprising a pressure sensing membrane.

20. An item tracking system for tracking an item, said system comprising an apparatus fitted to a container and a server, wherein said apparatus comprises a tag detector for detecting whether a tag fixable to an item is present within the container, a processor unit and a wireless communication unit, wherein
the processor unit is connected to the tag detector and the wireless communication unit and arranged to control the wireless communication unit to transmit item tracking data indicative of the presence of the item in the container to the server.

21. (canceled)
